(19) United States
(12) Patent Application Publication
(10) Pub. No.: US 2005/0131720 A1
(43) Pub. Date: Jun. 16, 2005

(54) Methods and systems of span design

(76) Inventors: Robert T. Andrews, Pelham, AL (US); Terry L. Rann, Powder Springs, GA (US); Mark A. Hildebrand, Snellville, GA (US); Mary W. Roth, Marietta, GA (US); Marian F. Meyers, Acworth, GA (US); Joseph A. Upshaw, Jonesboro, GA (US); Ramesh Movva, Alpharetta, GA (US)

Correspondence Address: WITHERS & KEYS FOR BELL SOUTH, P. O. BOX 71355, MARIETTA, GA, 30007-1355, US

(21) Appl. No.: 10/738,370

(22) Filed: Dec. 15, 2003

(51) Int. Cl. G06F 17/60

(52) U.S. Cl. 705/1

(57) ABSTRACT

Span design based on the organization of telecommunications components into a hierarchy of elements, segments, and/or architectures, the use of templates representing the hierarchy of components, and the conformity of the components to rules. In response to receipt of an order for digital services, the order data is used to obtain an assignment of components for the digital services. The order data and the assignment of components are used to obtain equipment data. The order data, the assignment of components and the equipment data are used to create the span design based on the templates.

### FIELD OF THE INVENTIONS

The inventions relate to the field of telecommunications, and particularly, to the field of span designs in provisioning digital telecommunications services to subscribers.

### BACKGROUND

Various digital telecommunications services are available to subscribers. Examples of such services include: Digital Signal Level 1 (DS-1), Digital Signal Level 3 (DS-3), and/or Trunk Carrier Signal Level 1 (T-1). To provide digital telecommunications service to a subscriber, additions or changes to the telecommunications network may have to be made.

With respect to the parts of the telecommunications network that may have to be added to or changed to provide a subscriber with digital service, the part of the telephone network that connects the subscriber to an appropriate central office (C.O.) of the telecommunications network is referred to as the “span” or “loop” for that particular subscriber. In some cases, a subscriber's “span” may be that part of the network directly between the subscriber's location and the nearest C.O. providing the desired digital service. In other cases, a subscriber's “span” may include a connection to a C.O., and then a further connection from the connected C.O. to one or more other C.O.s so as to provide the subscriber with the desired digital service.

When a subscriber subscribes to a digital service, a span design may have to be created so the appropriate elements, components, etc. are included in the span of the telecommunications network used to provide the digital service to the subscriber's location. Historically, span designs were created one-by-one and “manually” by a person reviewing the respective circumstances of each subscriber and adding or changing components in the telecommunications network, and particularly in the span, as appropriate. Additionally, a record of each span design is retained to aid in trouble shooting, trouble analysis and future rearrangements of the network.

Manual creation of a span design required the person creating the span design to determine the appropriate components to be used for a particular span. The determination of the appropriate components could involve checking for the availability or suitability of components as well as other checks. Some span designs contain a large number of components. Thus, it could take a person several hours, days, or even weeks to complete a span design.

In some cases, a span designer could make use of a portion of or a pre-existing span design in connection with a span design upon which he or she was working. Utilization of a pre-existing span design, in whole or part, did not typically save time in design of another span design. Generally, this process did not save any time because the span designer had to re-evaluate the pre-existing span design to insure its accuracy. Moreover, the span designer had to check for the continued availability or suitability of the components used in the pre-existing span design. As a result, manually providing each span design was a slow, inefficient, and cumbersome process.

Manually creating each span design, even though slow, inefficient, and cumbersome, was not considered a problem when few span designs were necessary. Previously, digital telecommunications services such as DS-1, DS-3, and T-1 services were primarily utilized only by consumers having high data volume or high telephone usage. For example, at first, only telemarketers, scientific companies, and similar entities utilized DS-1, DS-3, or T-1 lines. Thus, the pool of potential consumers was limited. Therefore, new span designs were required relatively infrequently.

Today, however, the pool of potential consumers for digital services is much larger thanks to the internet and other factors that have increased consumers' interest in and desire for digital services. Digital services such as DS-1, DS-3, and T-1 services may be and are utilized by just about anyone from internet service providers to family members. Consequently, many more span designs are needed to provide such services to consumers. Additionally, a majority of consumers expect services to be provided shortly after ordering the services. Therefore, in today's telecommunications market, the drawbacks of slowness, inefficiency and cumbersomeness associated with manually creating span designs are no longer acceptable.

In an attempt to address these drawbacks, digital provisioning computer programs were designed to mechanize the span design process. The digital provisioning programs included information about the available components and utilized the component information along with information input by a person to create a span design.

The digital provisioning programs, however, had their own drawbacks. One drawback was that the programs generally were inflexible because they could not be easily updated to address changes in components or otherwise adjust to changed circumstances. For example, new architectures and components were being and continue to be designed and utilized for DS-1 services. The digital provisioning programs that were developed prior to the new architectures or components did not include nor address issues related to the new architectures or components.

Typically, when technology evolved with new architectures or components, the digital provisioning programs required major reprogramming or overhaul. Even if a digital provisioning program was overhauled to include new architectures or components, the overhauled digital provisioning program would be out-of-date just as soon as even newer architectures or components came into usage.

Another drawback of the digital provisioning programs was that the reprogramming of the programs could generate additional problems. The digital provisioning programs became more complex and convoluted with each reprogramming or overhaul. Thus, reprogramming, and even running, a digital provisioning program could become increasingly more expensive with each overhaul.

Yet another drawback of the digital provisioning programs was that they often inadequately addressed significant increases in workload with respect to span design. Generally, the digital provisioning programs processed each span design in the same manner by processing one span design at a time. Some of the drawbacks associated with increased workload could have been addressed by increasing the number of employees and/or the number of hours that employees were working. An obvious problem with increased workload or increased personnel is that it has the potential to become financially prohibitive, a negative influence on employee morale, etc.

In sum, there is a need for methods and systems of dynamic, cost effective, and flexible span design that have the ability to easily address increasing workloads, new architectures or components, or changed circumstances.

### SUMMARY OF THE INVENTIONS

The methods and systems according to the inventions overcome the drawbacks of the prior art. The inventions provide systems and methods for span design for the provisioning of digital services in the telecommunications industry. The inventions may be implemented through a computerized methodology to dynamically add, change or delete components such as network elements, segments, or architectures used in span design. The inventions may include rules that govern the components, and the relationships among them as well as other factors of the telecommunications environment. The inventions provide span design methods and systems that may be altered with minimal or no effort, but yet meet the continuously changing environment of the provisioning of digital services in the telecommunications industry.

Generally stated, the inventions receive an order for digital services, create a span design, send the span design to the field force, and may provide information to the appropriate entities.

An exemplary method of the inventions provides a span design in response to receipt of an order for digital services. The order data is used to obtain an assignment of components for the digital services. The order data and the assignment of components are used to obtain equipment data. The order data, the assignment of components, and the equipment data are used to create the span design. An administrative review of the span design may be conducted such as a check that each of the components in the span design conforms to one or more rules. If appropriate, the span design may be sent to the field force for implementation of the span design for the provision of the digital services.

Particularly, the span design may be based on a hierarchy of components including elements, segments, and architectures. The elements are the basis of the hierarchy. Elements may be combined to form a segment. Segments may be combined to form an architecture. Other combinations of the components in each type in the hierarchy may be used. Further, each component conforms to one or more rules.

Another embodiment of the inventions provides another method for creating a span design for digital services. In this exemplary method, templates are developed for use in creating span designs. A template may be a representation of one or more components for the provision of the digital services. The components comply with rules. The components in a template may include element(s), segment(s), architecture(s), or any combination thereof. When an order for digital services is received, the order data and other information may be used to select one or more of the templates as a span design for the order. The other information may include an assignment of components and equipment data.

The inventions also include an exemplary system for span design in provisioning digital services. The system includes a main module for receipt of an order for the digital services. The main module provides the order data to an assignment control system (ACS). The ACS makes an assignment of one or more components for the digital services and provides the main module with the assignment data. The main module provides the assignment data and may provide the order data to an inventory module (IM). The IM uses the assignment data and may use the order data to determine equipment data, and provides the equipment data to the main module. The main module uses the order data, the assignment data, and the equipment data to create the span design for the digital services.

In the exemplary system, the main module may create the span design based on templates. The templates may include one or more element templates. Each of the element templates may represent an element. The templates may include one or more segment templates. Each of the segment templates may represent a segment, which may include one or more elements. The templates may include one or more architecture templates. Each of the architecture templates may represent an architecture, which may include one or more segments.

In sum, the inventions allow for relatively quick, cost effective, and efficient span design to accommodate the increasing numbers of orders from customers for digital services. Such quick, cost effective, and efficient span design is brought about by one or more of the features of the inventions such as the organization of telecommunications components into a hierarchy, the use of templates based on the hierarchy, and the application of rules to each of the components in a span design.

These and other feature and advantages of the methods and systems according to the inventions may be more clearly understood and appreciated from a review of the following detailed description of the preferred embodiments and by reference to the appended drawings and claims.

### BRIEF DESCRIPTION OF THE DRAWINGS

FIG. 1 is a block diagram of an exemplary environment for the inventions.

FIG. 2 is a block diagram of an exemplary digital provisioning client-server network.

FIG. 3 is a flow diagram of the actions taken by an exemplary digital provisioning client-server network.

FIG. 4 is a flow diagram of some actions taken by an exemplary embodiment of the inventions.

FIG. 5 illustrates an example of the hierarchical organization of elements, segments, and architectures as may be used with the inventions.

FIG. 6 is an exemplary template table.

FIG. 7 is a flow diagram of some actions taken by an exemplary embodiment of the inventions.

FIG. 8 is an exemplary rules table.

### DETAILED DESCRIPTION

The detailed description uses a number of acronyms that are generally well known in the art. Definitions are typically provided with the first instance of each acronym, but for convenience, Table 1 below provides a list of some of the acronyms and abbreviations used herein along with the terms they represent.

TABLE 1

| ACRONYM | DEFINITION |
|---|---|
| CFA | Carrier Facility Assignment |
| CKL | Circuit Location |
| C.O. | Central Office |
| DPRO | Digital Provisioning computer program |
| DS-1 | Digital Signal Level 1 |
| DS-3 | Digital Signal Level 3 |
| DSL | Digital Subscriber Line |
| FID | Fielded IDentifier |
| GUI | Graphical User Interface |
| HDSL | High Bit Rate Digital Subscriber Line |
| LEIM ™ | Loop Electronics Inventory Module |
| LFACS | Loop Facility Assignment Control |
| | System |
| NPA | Numbering Plan Area (a.k.a. Area |
| | Code) |
| PC | Personal Computer |
| PDA | Personal Digital Assistant |
| PSTN | Public Switched Telephone Network |
| RMA | Request for Manual Assistance |
| SOAC | Service Order Analysis and Control |
| SONET | Synchronous Optical Network |
| SUB | Subsection Routing Code (a.k.a. Sub |
| | number) |
| T-1 | Trunk Carrier Signal Level 1 |
| TIRKS ™ | Trunks Integrated Records Keeping |
| | System |
| ZNEA | A specialized Fielded Identifier (FID) on |
| | a service order indicating local facility |
| | assignments are NOT required. The |
| | letters have no particular meaning. |

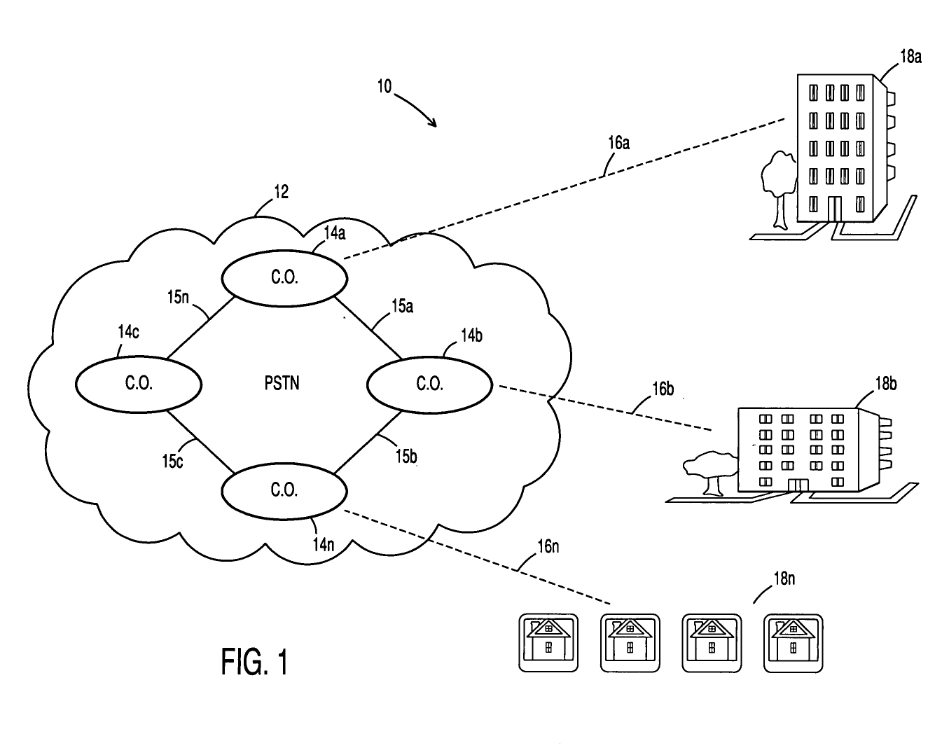

An Exemplary Environment—FIG. 1

FIG. 1 illustrates an exemplary environment 10 for the inventions. The exemplary environment 10 includes a Public Switched Telephone Network (PSTN) 12 with a network of interconnected central offices (C.O.s) 14a-n. A C.O. also may be referred to as an end office (E.O.), a service switching point (SSP), or a terminating office (T.O.).

C.O.s 14a-n may utilize connections 16a-n to users 18a-n. A connection may be any type of link, respectively, between a C.O. 14a-n and a user 18a-n that may be used for high data rate communications. For example, a connection may be, without limitation, a fixed line, a digital subscriber line (DSL), a T-1 line, a T-3 line, a cable, a satellite link (both high and low earth orbit), high speed fixed or spread spectrum wireless, hybrid wireless/fixed lines, VDSL/FTTC (Very-High-Data-Rate DSL/Fiber-to-the-Curb), power lines, etc. Further, the connections 16a-n need not be all of the same type; nor do each of the connections 16a-n have to be of a different type.

A user 18a-n may be any person and/or entity that uses digital telecommunications service. For example, a user 18a-n may be, among other things, a person at his or her home, an internet service provider, a telemarketing company, an educational or medical institution, a business or service organization operating in an office or other building, or other entity.

Digital telecommunications service generally refers to high data rate communications such as DS-1 service, DS-3 service, T-1 service, or the like. Digital telecommunications service also may be referred to as digital service.

When a user 18a-n subscribes to digital service, a check is made by the service provider to determine whether there is an appropriate path by which to provide the service to the user. That portion of the path between the user 18a-n and the element of the PSTN 12 connecting the user 18a-n to the digital service is referred to as the span with respect to that user 18a-n.

A user's span may be the connection between the user 18a-n and the PSTN 12. For example, in FIG. 1, user 18a is connected via connection 16a to the PSTN 12, and in particular, to C.O. 14a of the PSTN 12. In this example, C.O. 14a is appropriately configured to provide the user 18a with digital service. Thus, the span of user 18a is the connection 16a.

In some cases, the C.O. serving a user may not include or have access to components appropriate to providing the user with digital service. In that case, the user's span used in the provisioning of digital service to the subscriber may include the C.O. serving the user and its connection to another element of the PSTN. For example, in FIG. 1, assume C.O. 14b does not include the appropriate components to provide user 18b with digital service. When user 18b subscribes to digital service, the span used in the providing of digital service to user 18b includes connection 16b between the user and C.O. 14b, and the connection 15a that links C.O. 14b to C.O. 14a, which provides digital service.

In some cases, the span may be limited to the path between two elements of the PSTN. For example, assume digital service is to be provisioned to C.O. 14b where a co-located Local Exchange carrier has a presence. Also, assume C.O. 14c provides digital service. Thus, the span for provisioning C.O. 14b with digital service may include the connection 15b between C.O. 14b and C.O. 14n and the connection 15c between C.O. 14n and C.O. 14c.

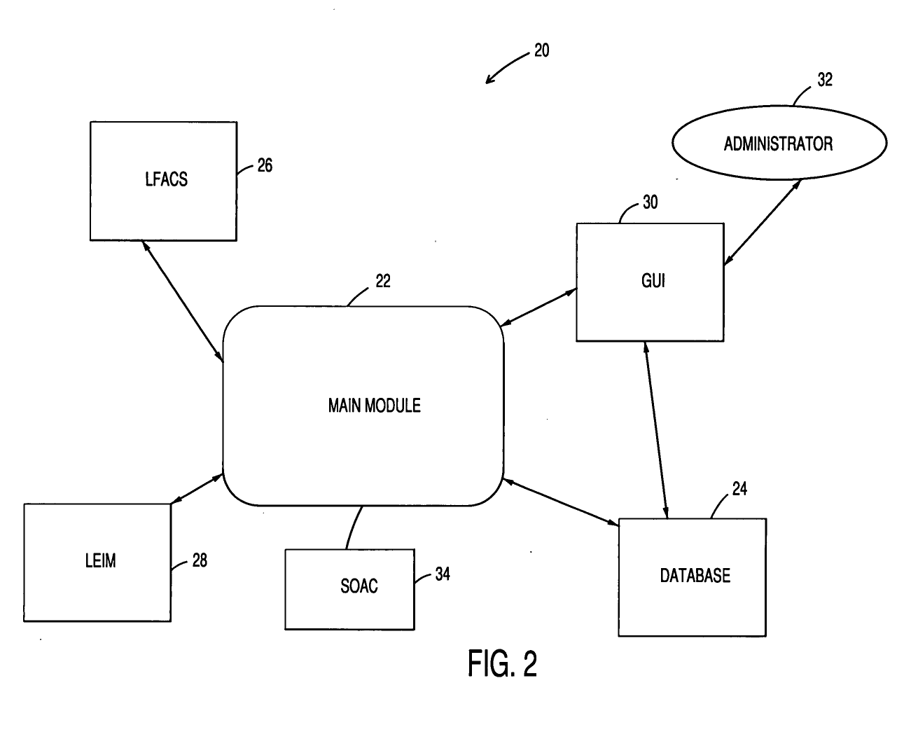

An Exemplary Digital Provisioning Network—FIG. 2

The inventions include methods and systems that may be used for creating span designs for providing digital services. A span design is a design of the features, components, elements, etc. that are part of the span of the telecommunications network used to deliver digital services to a user.

An exemplary system may be a network involving the interaction of one or more servers and one or more clients within a “client-server” network. The “client-server” network may refer to a hardware configuration, to a software configuration, or to a combination thereof. Any device or program may be capable of acting as a client and/or a server depending on the role the device or program plays based on the nature of the connection between the device or program and other elements. In other words, rather than a specific type of device or program, the terms “client” and “server” refer to the role a device or program performs during a specific connection or communication with another device, program, or element.

An exemplary system of the inventions, referred to as a Digital Provisioning Network 20 (DPRO), is illustrated in the block diagram of FIG. 2. DPRO may also be implemented as a computer program or otherwise. In this example, DPRO 20 is a client-server network including, but not limited to, a main module 22, a database 24, a Loop Facility Assignment Control System 26 (LFACS), a Loop Electronics Inventory Module 28 (LEIM™), Service Order Analysis and Control 34 (SOAC), a Graphical User Interface 30 (GUI), and an administrator 32.

In this example, the main module 22 of DPRO 20 is communicatively connected to database 24, LFACS 26, LEIM™ 28, SOAC 34 and GUI 30. The database 24 is also communicatively connected to GUI 30, which is communicatively connected to the administrator 32.

In the exemplary DPRO 20, the main module 22 acts as a server in the client-server network, and may also be referred to as a Digital Provisioning module (DPRO module). The main module 22 may be a client-server network or the like.

Generally stated, the exemplary DPRO is designed to receive an order for digital services, create a span design, send the span design to the field force, and provide information to the appropriate entities.

Particularly, the main module 22 of the exemplary DPRO 20 receives an order. Typically, the order is received from SOAC 34, but may be received from other sources such as a user 18a-n, another client or element in DPRO, or elsewhere.

In this exemplary embodiment, there are two types of orders: a service order and a work order. A service order is a set of instructions that may specify the following: what type of digital service is to be provided; for whom the service is to be provided; and where the service is to be provided. For example, a service order may specify that a particular customer has requested DS-1 service for the customer's place of business. A service order is generally created from a customer's request, but may be provided to DPRO by an administrator, a server, client, or other entity connected to DPRO. A service order may contain user information including, but not limited to, identification of the customer, a specific location, type of digital service desired, and when the service is needed. Additionally, a service order may include a customer's billing information.

Alternatively, an order may be a work order. A work order is like a service order, but typically a user does not initiate a work order. Instead, a work order may be initiated by an administrator to address a problem or potential problem with an existing span design. For example, an administrator may issue a work order to re-route DS-1 service to a particular user due to the physical relocation of a remote terminal. Analogous to a service order, a work order may specify user information including, but not limited to, the identity of the user, a specific location, type of service desired, and when the service is needed.

As noted above, the main module 22 of the exemplary DPRO 20 illustrated in FIG. 2 is communicatively connected to other elements. One of these elements is database 24, which may be utilized to store information. Among other things, database 24 may be a log, a record, a table, or a storage device. For example, database 24 may be a storage device that records and stores information (also referred to as order data) from an order received by DPRO 22. As another example, the main module 22 may access the database 24 for various reasons as explained below.

The main module 22 of the exemplary DPRO 20 is also communicatively connected to the Loop Facility Assignment Control System 26 (LFACS). LFACS may contain inventory information regarding components that are available for use in providing digital services and that may be incorporated in a span design. The components may include cables, pairs, and terminals. A “pair” refers to the two wires that make up the user's loop for telecommunications service between the user and the C.O. serving the user. A “cable” is a wire or a group of wires capable of carrying voice or data communications. A “terminal” is a connection point for elements such as a pair or cable with regard to the transmission of voice or data communications.

The inventory information of LFACS may identify each cable by cable name, and include information on each cable's length and gauge. The inventory information may identify the pairs by pair numbers and the terminals by terminal addresses.

In the course of creating a span design, the main module 22 may provide LFACS 26 with order data from the order for digital services. In response, LFACS 26 may provide the main module 22 with an assignment including assignment data relating to the assigned components.

The main module 22 of the exemplary DPRO 20 may be communicatively connected to the Loop Electronics Inventory Module 28 (LEIM™). LEIM™ 28 may store data on equipment that may be used as components in a span design. The data may be referred to as equipment data and may include: equipment name (including series or other identifier), equipment features, physical location of the equipment, relay rack information relating to the equipment, etc. For example, LEIM™ 28 may store data on connections for digital signal cross connect panels for the equipment, as well as equipment data for, among other things, multiplexers, repeater shelves, line repeaters, etc.

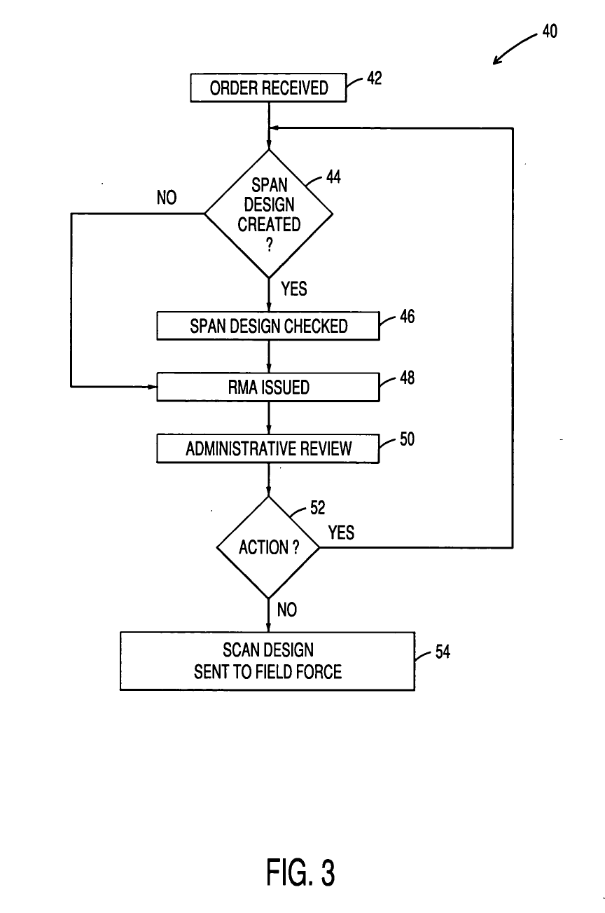

LEIM™ 28 may store equipment data such as information on the availability for use of any particular piece of equipment as a component or part of a component in a span design. In the course of creating a span design, the main module 22 may provide LEIM™ 28 with assignment data from LFACS 26. In response, LEIM™ 28 may provide the main module 22 with equipment data specific to the given assignment data, that is, the assigned components for the provision of the digital services relating to the span design. A component may be a network element, a network segment, or a network architecture. The differences among these types of components and their relationship is explained below in connection with FIG. 3.

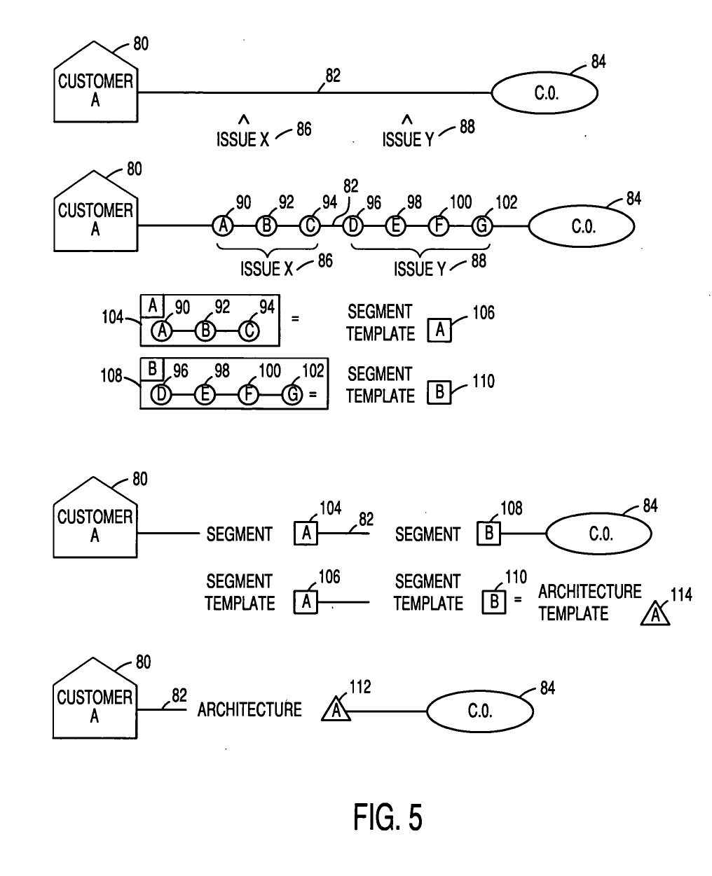

Additionally, the data associated with the network elements, network segments, and network architectures (discussed further in relation to FIG. 5) may be stored within any of the clients within the client-server network. For example, data regarding elements may be stored in LEIM™ LFACS, and/or the database.

The main module of the exemplary DPRO 20 may be communicatively connected to a graphical user interface 30 (GUI) or other interface. GUI 30 may be utilized for communications between DPRO 20 and an administrator 32. The GUI 30 generally may be 25 accessed through any device capable of displaying and/or printing information. For example, GUI 30 may be accessed through, among other things, a monitor, a workstation, an email account, a fax machine, a computer printer, a personal digital assistant (PDA), or a television screen.

Advantageously, GUI 30 is typically a Windows-based interface and therefore easy to understand and use for someone relatively familiar with Windows-based environments. The administrator 32 may utilize the GUI 30 to communicate with the main module 22 including review of, modification of, acceptance and/or rejection of suggestions and/or span designs from the main module 22. Additionally, the administrator 32 may utilize the GUI 30 to access and/or modify the database 24. The administrator 32 may be any person, entity, computer, automated program and/or the like responsible for operation of and monitoring the span design process. Even though only one administrator 32 is described in connection with this exemplary embodiment, there may be more than one administrator.

Once the exemplary DPRO 20 completes a span design, it may be provided to the field forces. Field forces may refer to an administrator and/or employee(s) responsible for the monitoring, operation, and/or physical implementation of span designs. Additionally, the exemplary DPRO 20 may provide information associated with a span design to other clients and/or servers outside of the client-server network associated with the exemplary DPRO 20. For example, the exemplary DPRO 20 may provide information associated with a span design to a record system such as the Trunks Integrated Records Keeping System (TIRKS™).

Flow Diagrams of an Exemplary Embodiment—FIGS. 3-7

FIG. 3 is a high level overview 40 of an exemplary DPRO provisioning process illustrated through use of a flow diagram. The process begins with the receipt of an order containing order data in action 42. Order data or other information associated with the data may be stored as well as acted upon as described below.

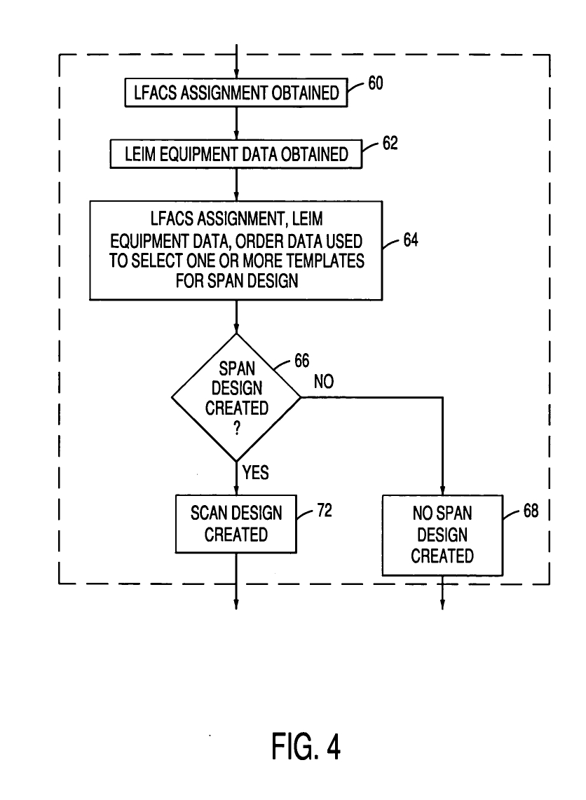

A span design is created or at least attempted in action 44. Details regarding the creation or attempts at creation of the span design are provided below with reference to FIGS. 3 and 4.

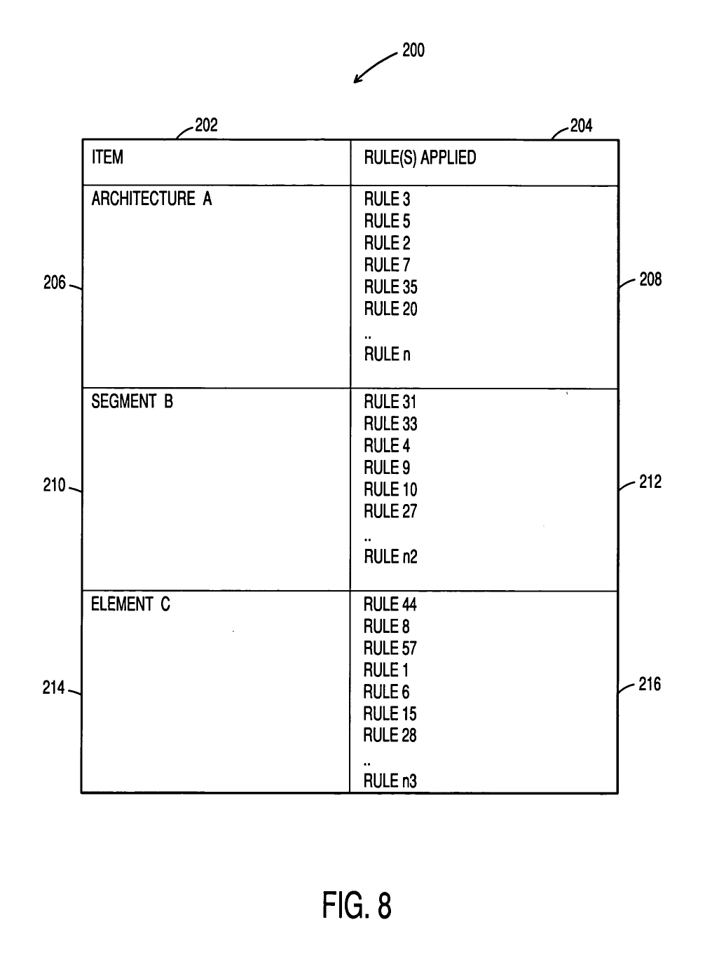

If a span design is created as determined in action 44, then in action 46, the span design is checked for compliance with the rules of DPRO. Details regarding exemplary DPRO rules are provided below with reference to FIG. 8.

The result of the compliance check is issued in a Request for Manual Assistance (RMA) in action 48. In the exemplary embodiment, an RMA is a notification provided to an administrator. As an example, an RMA may contain a proposed span design for an administrator to accept, reject, or modify.

Further, in the exemplary embodiment, an RMA may be distinguished as one of two types: a span design level RMA; or a non-span design level RMA. A span design level RMA is an RMA related to a span design, and may include or reference a span design. For example, a span design level RMA may include an RMA issued when the main module accesses a rules template (rules templates are described below in relation to FIG. 8).

A non-span design level RMA is an RMA that is unrelated to a span design. Non-span design level RMAs may include, among other things, service order RMAs, LEIM™ RMAs, and LFACS RMAs. Service order RMAs may refer to (ZNEA) errors (errors where the usage (presence or absence) of the ZNEA FID is ambiguous, etc. LEIM™ RMAs may refer to warnings that no relevant data exists in LEIM™, etc. LFACS RMAs may address incomplete assignments, problems accessing LFACS, missing order data in LFACS, location not matched in LFACS, LFACS being unavailable, etc.

Generally, span design level RMAs require some action such as corrective action by the administrator prior to proceeding with the provisioning process than non-span design level RMAs. Non-span design level RMAs may not require any action by the administrator.

An RMA's type may determine the manner in which the administrator addresses the RMA. Additionally, an RMA's type may require a different level of importance and/or urgency from another type of RMA. For example, span design level RMAs may signal a greater level of urgency than non-span design level RMAs. Advantageously, the categorization of RMAs by type gives an administrator flexibility in addressing RMAs. This flexibility may allow for faster, more efficient span design.

Referring again to action 44 of determining whether a span design has been created, if no span design is created, then the exemplary process issues an RMA in action 48. The RMA may include information on why the span design was not created.

The RMA is reviewed in action 50, preferably by an administrator. The review may result in action with respect to the processing of the order. If so, then the process may re-start (with the action completed or otherwise) with the action of span design creation or at least attempt at creation in action 44. If the review of the RMA results in a finding that no further action is necessary with respect to the span design, then the span design may be sent to the field force in action 54.

More particularly, the review of the RMA in action 50 may present the administrator with a proposed span design. An administrator may accept the proposed span design, reject the proposed span design, or make modifications to it.

If the administrator accepts the proposed span design, then as noted above, in action 52 a determination is made that no further action is necessary and in action 54 the proposed span design is sent to the field force as the span design for the order.

If the administrator rejects the proposed span design, then typically the administrator provides information, modifies information, or takes other action. Based on the action, the exemplary DPRO process may re-start so as to create another proposed span by returning to action 44 of FIG. 3.

If the administrator makes modifications to the proposed span design, a determination may be made as to whether or not the changes altered any critical aspects of the proposed span design or otherwise affected information related to the proposed span design. If the changes did not alter any of the critical aspects of the span design or related information, the changed proposed span design may be sent to the field force as the span design for the order.

If, however, a critical aspect of the proposed span design or related information was altered by the administrator, the proposed span design may be re-processed according to the actions described above to insure that the changes made by the administrator to the proposed span design did not affect another portion of the proposed span design.

An example of a situation when an administrator might make a modification to a span design is where the administrator is aware of changes that not yet be accounted for within an exemplary DPRO. For example, an administrator may know that a particular component selected for use within the span design has been replaced by another component (e.g.: an updated component). Thus, the administrator may modify the proposed span design to take into account the updated component.

Advantageously, the exemplary DPRO process is dynamic in adjusting to changes in data that may affect the design for a span of a consumer ordering digital services. For example, the exemplary method may create a span design and submit the span design for review. If the review results in a change in data upon which the span design is based, then the exemplary method processes the changed data and creates a span design based on the changed data.

Another advantage of the exemplary DPRO is that an administrator may halt the process of creating a span design at any point, yet utilize the span design created up to that point in the span design process.

Span Design Creation

There may be several stages with regard to span design. In the exemplary DPRO, among the first stages of span design is a determination of whether the received order is new. A new order is an order including order data or other information that is deemed critical and that has not previously been received or processed by DPRO. Thus, a new order may be an order that is received for the first time prior to any processing by DPRO.

Further, a revised order (or not new) may be an order that has been previously processed by DPRO, and as a result, includes order data or other information that is deemed critical and that may have been changed during or after DPRO processing. As an example, refer to the overview illustrated in FIG. 3 wherein an order may be processed through the described actions, but have to “re-start” the process as a result of a change on the order or otherwise. After the administrative review 50, action 52 may be taken to update or change order data or other information associated with the order. If the changes are made to critical order data or other information, then the order is considered to be “revised” during its reprocessing. Critical order data may include data associated with circuit location (CKL), the subsection routing code (SUB), numbering plan area (NPA), network exchange (NXX), address, carrier facility assignment (CFA), absence or presence of the ZNEA FID, line code, or framing.

A reason for determining whether the order is new or not new is that an order that is not new may, in some cases, more quickly process through the exemplary DPRO than a new order. The order that is deemed to be not new may process faster typically because less processing is required. For example, an order that is not new may not require the exemplary DPRO to access LFACS or LEIM as the data may already be stored in the database.

The exemplary DPRO may utilize a differencer to determine whether or not the order data is new. A differencer compares stored versions of the order data (if any) with the version of the order data just received.

FIG. 4 illustrates details regarding the action of span design or attempt(s) at span design generally itemized as action 44 in FIG. 3. In the exemplary DPRO, as shown by action 60, a loop facility assignment control system (LFACS) assignment is obtained. An LFACS assignment also may be referred to as an assignment.

The example illustrated in FIG. 4 assumes an LFACS assignment is obtained. This may not always be the case, and there may be a failure to obtain an LFACS assignment. LFACS may determine that a critical component or components necessary to provide an assignment for the order is missing or unavailable given the requirements of the order or order data. If no LFACS assignment is obtained, then no span design is created as noted by action 68 in FIG. 4, and the DPRO process continues as described with reference to action 48 (RMA issued) in FIG. 1. The RMA may, for example, request the administrator to provide additional information, or specify what action to take when LFACS assignments cannot be obtained. The RMA may notify the administrator that the order data did not contain sufficient information, LFACS could not locate the requisite components, the assignment is incomplete, etc.

In the exemplary embodiment, an LFACS assignment includes components selected to be used in the span design for the provisioning of the digital services relating to the order. The selection of the components for the LFACS assignment is made with reference to the order data and to LFACS inventory information. The LFACS assignment may be made by LFACS, or by a user accessing the order data and inputting the LFACS inventory information via keyboard.

In an alternate embodiment, LFACS may receive the order data at the same time the main module receives the order data. LFACS may, at that time, make a determination as to whether LFACS may provide an LFACS assignment, or LFACS may have the LFACS assignment (or LFACS inventory information or other information) prepared so as to be ready to respond immediately after being accessed or queried.

As also illustrated in FIG. 4, in action 62 Loop Electronics Inventory Module (LEIM™) equipment data is obtained. LEIM™ equipment data also may be referred to as equipment data.

It is assumed in the example illustrated in FIG. 4 that LEIM™ equipment data is obtained. This may not always be the case that there may be a failure to obtain LEIM™ equipment data. If no LEIM™ equipment data is obtained, then no span design is created as noted by action 68 in FIG. 4, and the DPRO process continues as described with reference to action 48 (RMA issued) in FIG. 3.

LEIM™ equipment data includes data on equipment selected to be used in the span design for the provisioning of the digital services relating to the order. The selection of the equipment for the LEIM™ equipment data is made with reference to the order data, LEIM™ inventory information, and may be made with reference to the LFACS assignment. The LEIM™ equipment data may be specified by LEIM™, or by another element such as the database of the exemplary DPRO using the order data, the LEIM™ inventory information, the LFACS assignment, or other information.

In action 64, the LFACS assignment, the LEIM™ equipment data may be associated with the order data relating to the order for which a span design is being provisioned. The LFACS assignment, the LEIM™ equipment data, and the order data are used to select one or more templates to constitute the span design.

A template is a pattern of network element(s), segment(s), and/or architecture(s) that constitutes a span design or part of a span design. The exemplary DPRO uses template(s) to create a span design. A network element also may be referred to as an element, a network segment also may be referred to as a segment, and a network architecture also may be referred to as an architecture.

FIG. 5 illustrates the evolution of an exemplary template that may be used as a span design when appropriate. As noted, a template is a pattern of network element(s), segment(s), and/or architecture(s). The templates of the exemplary DPRO have been created based on issue(s) that must be addressed by the span designs or portions of span designs regarding the delivery of digital services.

Referring to FIG. 5, assume customer A 8 has placed an order for digital services and a span design must be created for the span 82 between customer A 80 and a central office (C.O.) 84. In this example, assume the span design must address two issues: issue X 86; and issue Y 88. Network elements A 90, B 92, and C 94 are used to address issue X 86, and network elements D 96, E 98, F 100, and G 102 are used to address issue Y 88 as illustrated in FIG. 4 by their inclusion in span 82.

In this example, both issue X 86 and issue Y 88 are relatively common issues faced in span design. Accordingly, the network elements A 90, B 92, and C 94 that address issue X 86 may be grouped together as network segment A 104. A record of this grouping of these network elements into a network segment A 104 that addresses issue X 86 is referred to herein as segment template A 106. Whenever the exemplary DPRO receives information that a span design must address an issue X, DPRO may use segment template A 106 as part of the span design to address such issue X.

As noted, network elements D 96, E 98, F 100, and G 102 address issue Y 88 that arises in the design for span 82 between the customer A 80 and C.O. 84. These network elements may be grouped together as network segment B 108. A record of this grouping of network elements into a network segment B 108 that addresses issue Y 88 is referred to herein as a segment template B 110. Whenever the exemplary DPRO receives information that a span design must address an issue Y, DPRO may use segment template B 110 as part of the span design to address such issue Y.

As shown in FIG. 5, a way to illustrate the span design for span 82 is to include segment A 104 connected to segment B 108 in span 82.

In this example, the presence of issue X 86 and issue Y 88 is a relatively common occurrence in span design. Accordingly, the segments that address these issues may be grouped into an architecture A 112. A record of this grouping of network segments into network architecture A 112 that addresses issue X 86 and issue Y 88 is referred to herein as an architecture template A 114. Whenever the exemplary DPRO receives information that a span design must address an issue X and an issue Y, DPRO may use architecture template 114 as the span design or part of it.

As shown in FIG. 5, another way to illustrate the span design for span 82 is to include architecture A 112 in span 82.

The exemplary DPRO gains several advantages by using templates based on a hierarchy of network elements, segments, and architectures for creating a span design. For example, using the templates in span design saves time. A template may be created for each issue or combination of issues that repeatedly arise in span design. Whenever an issue or combination of issues arises, the appropriate template may be used in the span design without resort to time-consuming analysis to determine the appropriate network element or combination of network elements to be used in the span design.

Another advantage of DPRO's templates is that they are based on the hierarchy of network elements, segments, and architectures explained above. This hierarchy allows for templates to be of different “sizes”. Templates may be of different “sizes” in that they may include one or more elements, one or more segments, one or more architectures, or combinations thereof. The different sizes of the templates allow for flexibility in the creation of a span design as well as time savings in such design. Referring to the example illustrated in FIG. 5, the span design for span 82 may quickly be determined to be architecture A 112 based on the dual issues of X and Y that must be addressed in the design. The need for determining which specific network elements are necessary to address these issues is avoided because they are specified by architecture template A 114.

Another example of how the templates speed up design span creation is illustrated by the circumstances of a span that presents issue X, issue Y, and issue Z. As noted above, a template of architecture A 112 may be used in the span design to address issues X and Y. Assume there is no template for issue Z (alone or in combination with issue X and/or issue Y). The exemplary DPRO may process the order including specification of architecture A 112 as part of the span design, and report the lack of a template for issue Z in an RMA. Thus, the administrator only has to address issue Z in the span design instead of having to address all three issues.

Yet another example of how the templates speed up span design relates to changes in elements that may be used in a span. An element may become obsolete, may be updated, or otherwise changed. A new element may become available. The use of templates easily accounts for such changes. An administrator may only have to change the template(s) including the changed element. The administrator does not have to revamp all of DPRO. Thus, the exemplary DPRO may be readily updated when an element change occurs.

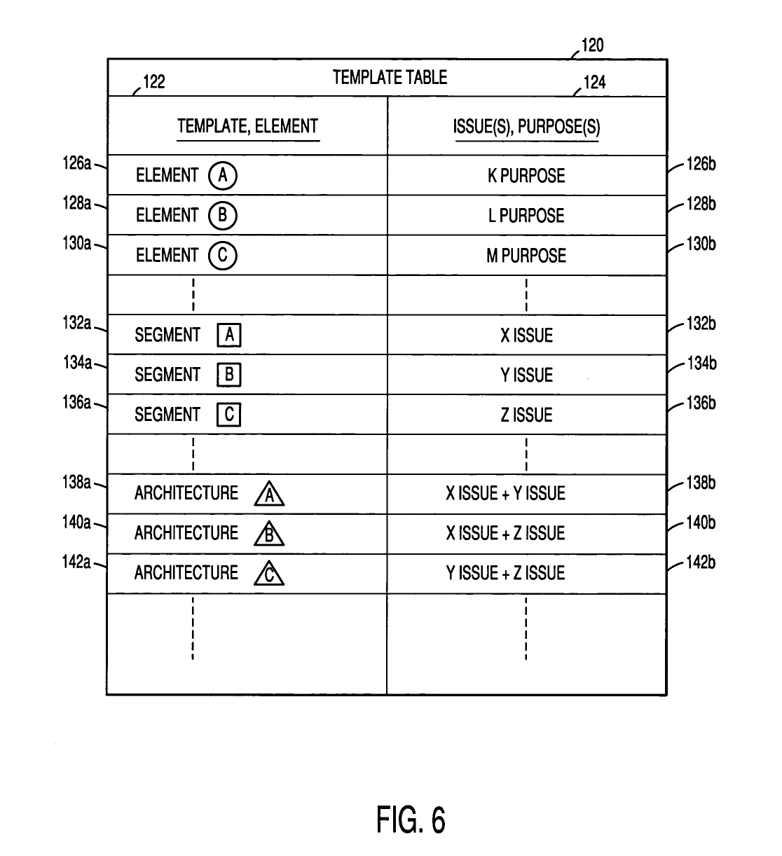

FIG. 6 illustrates an exemplary template table 120. The exemplary DPRO may use the template table 120 to determine which template(s) to use in connection with a span design. The illustrated template table 120 includes a column 122 for identification of the templates and a column 124 related to the issues addressed by the respective templates. Each entry in the table includes an identifier in column 122 and an issue or purpose in column 124.

The exemplary template table 120 includes entries relating to elements. In the exemplary embodiment, there is no need for a template for an element in a span design. An element is a singular object or device, which may be used in a span design for a specific purpose. Thus, the element entries 126a, 128a, and 130a in template table 120 each have a respective purpose (K purpose 126b, L purpose 128b, and M purpose 130b) identified in column 124 of the template table 120. Such entries relating to individual elements may be useful in some embodiments of the DPRO process.

The term “purpose” is used as a generic term to cover the many different reasons elements may be used in a span design. For example, element A 126a may be used for a particular function(s) that is(are) referred to as K purpose 126b. In the course of span design, if the particular function(s) that constitute(s) the K purpose are present, element A 126a may be selected for use in the span design.

The exemplary template table 120 also includes entries relating to segments. Typically, a segment includes more than one element and a segment may be used in a span design to address a particular issue. Template table 120 includes the following entries relating to segments: segment A 132a addressing X issue 132b; segment B 134a addressing Y issue 134b; and segment C 136a addressing Z issue 136b.

The term “issue” is used as a generic term to cover the many different reasons segments and architectures may be used in a span design. For example, segment A 132a may be used for a particular function(s) that is(are) referred to as X issue. In the course of span design, if the particular function(s) that constitute(s) the X issue are present, segment A 132a may be selected for use in the span design.

Further, the exemplary template table 120 includes entries relating to architectures. Typically, an architecture includes one or more elements, one or more segments, or one or more segments plus elements. An architecture generally is used to address more than one issue and/or purpose. Template table 120 includes the following entries relating to architectures: architecture A 138a addressing X issue plus Y issue 138b; architecture B 140a addressing X issue plus Z issue 140b; and architecture C 142a addressing Y issue plus Z issue 142b.

Exemplary template table 120 is included herein primarily for purposes of explanation of the principals of the inventions. The inventions may use or include other mechanisms for the storing of information related to templates, elements, segments, and architectures, and associated information.

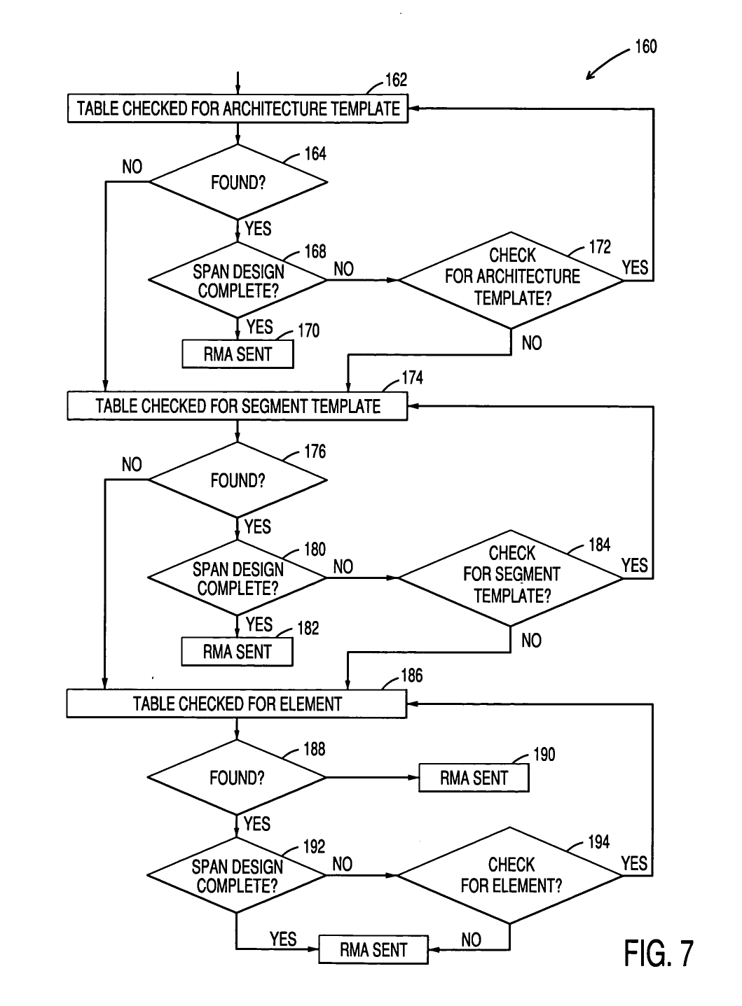

As noted above with reference to FIG. 4, action 64, a span design is created for an order by using the order data, the LFACS assignment, and the LEIM equipment data. The exemplary DPRO uses one or more templates to create the span design as explained with reference to the flow diagram of FIG. 7.

The creation of a span design may be viewed as a “top-down” approach based on the hierarchy explained above of architectures typically being made up of segments, segments and elements, and segments being made up of elements. The exemplary DPRO first checks whether an architecture template(s) may be used in the span design, then checks whether a segment template(s) may be used, and finally checks whether an element(s) may be used. Advantageously, this top-down approach based on the hierarchy of architecture-segment-element speeds span design. For example, a span design may be created that is based only on an architecture template. Once the exemplary DPRO has selected the architecture template, the span design may be considered complete.

FIG. 7 illustrates the top-down approach to span design as starting in action 162 with a check of the template table (described above with reference to FIG. 6) for an architecture template to be used in the span design. To aid in the explanation, assume the span design must take into account:
X issue+Y issue+Z issue+K purpose.
The exemplary DPRO checks the template table 120 for an architecture template that may relate to these issues and purpose.

If no architecture template is found in the check 164, then the span design process moves on to checking for segment templates in action 174 as explained below.

Referring to the example, the exemplary DPRO finds architecture A template 138a may be used to address:
X issue+Y issue
In action 168 the exemplary DPRO may check whether the span design is complete. If complete, then in action 170 an RMA may be sent. If the span design is incomplete as determined in action 168, then in action 172 a check may be conducted to see whether the template table needs to be checked again for an architecture template. If so, the process returns to action 162 and checks for the architecture template.

Still referring to FIG. 7, if no architecture template is found (action 164), or if the span design is incomplete (action 168) and there is no need for an architecture template check (action 172), then in action 174 a check is conducted for a segment template.

If no segment template is found, then the span design process moves on to checking for elements in action 186 as explained below.

Referring to the example, the exemplary DPRO finds that segment C template 136a may be used to address: Z issue. In action 180 the exemplary DPRO may check whether the span design is complete. If complete, then in action 182 an RMA may be sent. If the span design is incomplete as determined in action 180, then in action 184 a check may be conducted to see whether the template table needs to be checked again for a segment template. If so, the process returns to action 174 and checks for the segment template.

Still with reference to FIG. 7, if no segment template is found (action 176), or if the span design is incomplete (action 180) and there is no need for a segment template check (action 184), then in action 186 a check is conducted for an element template.

If no element template is found, then an RMA is sent in action 190.

Referring to the example, the exemplary DPRO finds element A 126a may be used to address: K purpose. In action 192 the exemplary DPRO may check whether the span design is complete. If complete, then in action 196 an RMA may be sent. If the span design is incomplete as determined in action 192, then in action 194 a check may be conducted to see whether the template table needs to be checked again for an element template. If so, the process returns to action 186 and checks for an element template. If there is no need for an element template check (action 194), then an RMA is sent in action 196.

Using the above-described top-down approach, the span design created to address the example of:
X issue+Y issue+Z issue+K purpose
has created the following span design of:
Architecture A+Segment C+Element A

The top-down process of span design described above is one way in which the hierarchy of architectures-segments-elements may be taken advantage of. Other processes may be used. For example, a “bottom-up” process may be used where elements are first selected for an order. After selection, the elements may be determined to constitute segments, and the segments or segment(s) plus element(s) may be determined to constitute architectures. Other processes using the hierarchy of elements-segments-architectures will occur to those skilled in the art.

Rules—FIG. 8

Among the features of the exemplary DPRO is the feature of uniformity with respect to types of elements, segments, and architectures. The uniformity generally allows for problem-free span design. Typically, there are no surprises or unexpected problems in the span design created by the exemplary DPRO because the elements, segments, and architectures are uniform with respect to each of their types. Since each element A is like every other element A, use of a particular element A does not generally result in problems because the particular element A is a “standard” element A with no quirks or special requirements.

The uniformity of types of elements, segments, and architectures in the exemplary DPRO is brought about by the application of a “rule” or “rules”. Each respective type of element, segment, or architecture satisfies the rule or rules applied to it. A rule may cover a feature or specification relating to an element, segment, or architecture. A rule may relate to the relationships between elements, elements and segments, elements and architectures, segments and segments, segments and architectures, and architectures and architectures. A rule may relate to the order of developing templates for use in elements, segments, or architectures. A rule may relate to conditions that may exist prior to processing of the span design without being specifically related to any architecture, segment or element. A rule may relate to the level of service (DS1, T1, DS3, etc.) being processed. A rule may also relate to the display of the completed design in the output or to whom the output is sent.

FIG. 8 illustrates an exemplary Rules Table 200. The Rules Table 200 includes a column 202 for a particular item such as an element, a segment, or an architecture. The Rules Table 200 also includes a column 204 for the rule(s) applied to the corresponding item. The exemplary Rules Table 200 includes three entries with each entry including an item and a rule(s). The first entry, Architecture A 206, is governed by the set of rules 208: Rules 3, 5, 2, 7, 35, 20 through n. The second entry, Segment B 210, is governed by the set of rules 212: Rules 31, 33, 4, 9, 10, 27 through n2. The third entry, Element C 214, is governed by the set of rules 216: Rules 44, 8, 57, 1, 6, 15, 28 through n3.

In the exemplary DPRO, the conformity of any particular element, segment, or architecture may be checked against its respective rule(s). To promote the consistency of span design in the exemplary DPRO, the conformity of any particular element, segment, or architecture may be checked during span design. Such a check may be carried out when an element, segment, or architecture is selected for the span design. Alternatively, or in addition, a check may be carried out when the span design is considered complete.

Based on the elements-segments-architectures hierarchy, the exemplary DPRO carries out a “bottom-up” check of the conformity of the element(s), segment(s), and/or architecture(s) in a span design. The bottom-up conformity check is viewed as advantageous because it is often more efficient than other types of conformity checks. For example, the bottom-up conformity check carries out its check with respect to all of the element(s) present in a span design. Thus, when the bottom-up conformity check reaches the segment(s) and/or architecture(s) in the span design, the conformity check does not have to re-check the elements within the segment(s) and/or architecture(s).

If a conformity check with respect to any component in a span design results in a finding that the component does not conform to its corresponding rules, then an RMA may be issued. Action may be taken to bring the component into compliance or to substitute a different component or combination of components.

Conclusion

In sum, the exemplary DPRO provides advantageous methods and systems of span design for digital services. The exemplary DPRO facilitates relatively quick, cost effective, and efficient span design to accommodate the increasing numbers of orders from customers for digital services. In addition, the exemplary DPRO has flexibility to address evolving developments in technology, increasing workloads, and changed circumstances.

From the foregoing description of the exemplary embodiments of the inventions and operation thereof, other embodiments will suggest themselves to those skilled in the art. Therefore, the scope of the inventions is to be limited only by the claims below and equivalents thereof.

1. A method for provisioning a span for digital services, comprising:
receiving an order for the digital services;
using order data to obtain an assignment of components for the digital services;
using the order data and the assignment of components to obtain equipment data; and
using the order data, the assignment of components, and the equipment data to create a span design for the provision of digital services.

2. The method of claim 1, further comprising conducting an administrative review of the span design.

3. The method of claim 1, wherein the span design is created based on a hierarchy of the components.

4. The method of claim 3, wherein the hierarchy of the components comprises: elements, segments, and architectures.

5. The method of claim 3, wherein the hierarchy of the components comprises: elements, segments with each segment including one or more of the elements, and/or architectures with each architecture including one or more segments.

6. The method of claim 1, wherein each component conforms to one or more rules.

7. The method of claim 2, wherein conducting the administrative review of the span design comprises checking whether each component conforms to one or more rules.

8. A method for creating a span design for digital services, comprising:
developing templates for use in creating span designs;
receiving an order for digital services; and
using order data to select one or more of the templates as a span design for the order.

9. The method of claim 8, wherein a template comprises a representation of one or more components for provision of the digital services.

10. The method of claim 8, wherein a template comprises a representation of one or more elements, one or more segments, and/or one or more architectures.

11. The method of claim 8, wherein using the order data to select the one or more of the templates as the span design for the order comprises:
using the order data to select one or more architecture templates, one or more segment templates, and/or one or more element templates as the span design for the order.

12. The method of claim 8, wherein using the order data to select the one or more templates as the span design for the order comprises:
using the order data and an assignment of components to select the one or more templates as the span design for the order.

13. The method of claim 12, wherein using the order data and the assignment of components to select the one or more templates as the span design for the order comprises:
using the order data, the assignment of components, and equipment data to select the one or more templates as the span design for the order.

14. The method of claim 9, wherein each component conforms to one or more rules.

15. A system for provision of a span design for digital services, comprising:
a main module for receipt of an order for the digital services;
the main module being operative to provide order data from the order to an assignment control system (ACS);
the ACS being operative to make an assignment of one or more components for the digital services, and to provide the main module with assignment data relating to the assignment;
the main module being operative to provide the assignment data to an inventory module (IM);
the IM being operative to use the assignment data to determine equipment data, and to provide the equipment data to the main module; and
the main module being operative to use the order data, the assignment data, and the equipment data to create the span design for the digital services.

16. The system of claim 15, wherein the main module is operative to create the span design based on templates.

17. The system of claim 16, wherein the templates comprise:
one or more element templates;
one or more segment templates; or
one or more architecture templates.

18. The system of claim 16, wherein a template comprises a representation of the one or more components for the digital services.

19. The system of claim 15, wherein components used for implementation of the digital services are hierarchically organized based on elements, segments, and/or architectures.

20. The system of claim 19, wherein each of the components comply with one or more rules.
